(19) United States
(12) Patent Application Publication
(10) Pub. No.: US 2022/0073416 A1
(43) Pub. Date: Mar. 10, 2022

(54) METHOD FOR ENGINEERED POLYPHASE CELLULAR MAGMATICS AND ARTICLES THEREOF

(71) Applicant: GlassWRX, LLC, Beaufort, SC (US)

(72) Inventors: Robert Michael Hust, Coeur d'Alene, ID (US); William Gene Ramsey, Warrenville, SC (US); Gert Nielsen, Albuquerque, NM (US); Collin James Wilkinson, State College, PA (US)

(73) Assignee: GlassWRX, LLC

(21) Appl. No.: 17/469,200

(22) Filed: Sep. 8, 2021

Related U.S. Application Data
(60) Provisional application No. 63/076,347, filed on Sep. 9, 2020.

(51) Int. Cl. C03C 11/00; C03B 19/08; C03C 10/00

(52) U.S. Cl. CPC C03C 11/007; C03C 2204/00; C03C 10/00; C03B 19/08

(57) ABSTRACT

Methods for engineered polyphase cellular magmatics and articles thereof are disclosed. For example, the magmatics may include multiple phases including a crystalline phase and an amorphous phase. The magmatics may also include one or more reactive agents that may be disposed within cell structures of the magmatics and/or on an exterior of the magmatics, giving the resulting magmatics reactive properties that may differ based on the selected reactive agents and/or placement of the reactive agents within and/or through the magmatics.

### RELATED APPLICATIONS

This application claims priority to U.S. Provisional Patent Application No. 63/076,347, filed on Sep. 9, 2020, the entire contents of which are incorporated herein by reference.

### BACKGROUND

The production of glass and/or ceramic aggregates may be beneficial in multiple use cases. Such aggregates have uniform structures and/or properties. Described herein are improvements and technological advances that, among other things, generate alternatives to conventional foamed glass.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the components on a larger scale or differently shaped for the sake of clarity.

FIG. 1 illustrates a cross-sectional view of an example polyphase cellular magmatic.

FIG. 2 illustrates a cross-sectional view of an example polyphase cellular magmatic with open and closed cells, along with non-vesicular pores.

FIG. 3 illustrates a cross-sectional view of an example polyphase cellular magmatic with interior and exterior reactive agents.

FIG. 4 illustrates a cross-sectional view of an example polyphase cellular magmatic with multiple layers and a reactive agent in different states across layers.

FIG. 5 is a flowchart illustrating an example process for generating polyphase cellular magmatics.

FIG. 6 is a flowchart illustrating another example process for generating polyphase cellular magmatics.

FIG. 7 illustrates a schematic view of a system for generating polyphase cellular magmatics.

### DETAILED DESCRIPTION

Methods for engineered polyphase cellular magmatics and articles thereof are disclosed. Take, for example, situations where silicate aggregates are to be made. Silicate aggregates, otherwise described herein as foam glass and/or ceramic aggregates, may be utilized for a number of purposes, such as insulation, remediation of waste, filler material, a component of concrete or other hardscape, and/or one or more other uses. Generally, silicate aggregates may be composed of a precursor material such as a glass-grade silica powder, ground glass, and/or silica-lime glass, for example. However, conventional silicate aggregates have a single composition, have homogenous and/or uniform properties, have a single density, have a single porosity, and/or are either open-celled or close-celled. Additionally, unlike the inert or nearly inert conventional silicate aggregates, the polyphase magmatics described herein may include one or more reactive agents that are predetermined to interact with one or more substances when those substances contact the reactive agents.

For example, a composition could consist of 5 wt % waste E-glass, 3 wt % Zeolites, 1.5 wt % CaCO3, then one percent of silicon carbide, calcium monophosphate, and Kaolin. The remainder is made out of consumer waste glass.

For example, the magmatics described herein are configured to bind a crystalline phase into an overall amorphous structure while making the crystalline phase available for interaction with other substances. In the scope of this document amorphous is defined as a bulk material or phase that consists of a non-crystalline structure which is also a non-equilibrium material. In examples, the crystalline phases are batch chemical phases (high refractory ceramic species) and/or crystalline phases derived from a phase change or chemical reaction with other crystalline or glassy components. Further, secondary species can be derived during firing or upon specific chemical treatment postproduction—imbuing an article that is predominately amorphous with a crystalline fraction.

The magmatics may also have closed cell structures and/or open cell structures. For example, a closed cell structure may comprise, in either the amorphous or crystalline phases, an open space that is not connected to other open spaces. By way of example, the magmatic may have open spherical voids in the amorphous and/or crystalline phases. When those spherical voids are not connected to other spherical voids, the voids may be closed cell. When those spherical voids are connected to other spherical voids, the voids may be open cell. The cells may be of uniform or about uniform size throughout the magmatic structure, or some or all of the cells may differ in size. Additionally, while spherical voids are described herein by way of example, various other shapes of voids may be generated. In some examples, the crystalline phase may not be associated with or otherwise contact the open and/or closed cell structures. In other examples, the crystalline phase may make up at least a portion of the wall of at least one cell structure (whether closed or open celled) in the magmatic. In addition to the above, the magmatic may include one or more non-vesicular pores, which may be described as tunnels or otherwise tubes that run through at least a portion of the magmatic.

In addition to the above, one or more reactive agents may be applied to the magmatic to imbue one or more portions of the magmatic with reactive properties. For example, the reactive agents may be selected during manufacture of the magmatics and may be disposed on certain portions of the resulting magmatic. By way of example, reactive agents may be disposed on one or more cell walls of a closed and/or open cell void in the magmatic. In some examples, a reactive crystalline agent may be disposed on a first portion of the magmatic while a reactive amorphous agent may be disposed on a second portion of the magmatic. Additionally, one or more reactive agents may be disposed on an exterior portion of the magmatic, such as when a postproduction imbuing is utilized. In these examples, the exterior reactive agent may be the same or different from the reactive agent disposed within the magmatic. Additionally, the exterior reactive agent may penetrate at least a portion of the magmatic, and in some examples may penetrate one or more of the cell structures of the magmatic.

Furthermore, the magmatics describes herein may include one or more layers of reactive agents. For example, during manufacturing of the magmatics, specific temperatures, dwell times, and/or heating gradients may be applied to cause at least a portion of a reactive agent to form a different chemical substance and/or state than the original reactive agent. In these examples, the original reactive agent and the different chemical substance and/or state may at least partially separate into one or more layers in the magmatic. By so doing, a first layer of the magmatic may include first reactive properties when one or more substances contact the first layer, and specifically the reactive agent of the first layer, while a second layer of the magmatic may include second, different reactive properties when one or more substances contact the second layer, and specifically the reactive agent of the second layer.

Also disclosed herein are methods for generating polyphase cellular magmatics. The methods may include creating a mixture of at least pulverized and/or powdered glass and pulverized and/or powdered blowing agent. The glass and/or blowing agent may be pulverized and/or powdered to a unit size specific to the application at issue and for the desired resulting magmatic. In examples, the grain size of the glass and/or blowing agent components may be smaller, sometimes significantly smaller, than the intended voids to be generated in the resulting magmatic. The glass component may include, for example, one or more of soda-lime glass, flint, container glass, a-glass, flat glass, e-glass, c-glass, ar-glass, s-glass, single phase borosilicate glass, phase separated borosilicate, fused silica, coal slags, metal slags, nickel slag, smelting slags, mineral wool, iron phosphates, aluminoborosilicates, vanadium oxides, and/or boron. It should be understood that these glass materials are provided by way of illustration, and not as a limitation. The blowing agents may include one or more of aluminum slag, anthracite, activated carbon, calcium carbonate, calcium sulfate, carbon black, cellulose, coal, fly ash, graphite, magnesium carbonate, potassium nitrate, silicon carbide, silicon nitride, sodium hydroxide, sodium nitrate, sodium nitrite, and/or zinc oxide. Again, it should be understood that these glass materials are provided by way of illustration, and not as a limitation.

The mixture may also include one or more reactive agents. The reactive agents may include, for example, alumina, bauxite, sodium aluminate, periclase, hematite, wüstite, magnetite, enamel, zircon, zirconium dioxide, silicon carbide, silicon nitride, garnet, spinel, kaolin, clays, zeolites, incinerator ash, and/or pyrolysis ash. Again, it should be understood that these reactive agents are provided by way of illustration, and not as a limitation.

The resulting mixture may be placed into a kiln or other heating component and a temperature may be applied until at least a portion of the blowing agent decomposes into a gas or gases, forming a distribution of cellular voids within the resulting foamaceous mass. In situations where a reactive agent is included in the mixture, application of heat in the kiln may be performed until, in examples, the reactive agent comprises a significant fraction of the surface area of the foamaceous mass and/or until the reactive agent comprises a residue on surfaces of the foamaceous mass. In examples, application of heat may be performed until, for example, the materials sinter and at least a portion of the mixture foams by thermal decomposition of the blowing agent and/or agents.

The temperature and dwell times may then be regulated such that at least a fraction of the cells of the foamaceous mass become interconnected by discontinuities in the cell walls. This discontinuity may be caused at least in part by pressure from escaping gases and/or constituent secondary blowing agents having a higher decomposition temperature than other blowing agents. The temperatures, dwell times, and heating gradients used with respect to the kiln may be adjusted to achieve a desired resulting magmatic. For example, adjusting one or more of the temperature, the dwell times, and/or the heating gradients may result in magmatics with differing cell size, porosity, open versus closed cells, inclusion or exclusion of non-vesicular pores, inclusion or exclusion of reactive agents on cell walls and/or other portions of the magmatic, differing densities, inclusion of more or less crystalline phase, inclusion or exclusion of layers, inclusion or exclusion of reactive agent derivatives, etc.

The magmatics described herein may include a rigid foamed mass, typified by an appearance akin to pumice or volcanic rock, that is manufactured in an artificial elevated temperature environment. Such articles may exhibit both open or closed-cell structures, as well as open and closed-cell structures in the same article. These articles may also exhibit pore structure comprised of interconnected cells where cell walls have collapsed to form subsequent vesicular corridors, or pore structures without creating discontinuities in cells, or a combination of these aspects. Engineered cellular magmatics (ECM) differ from foam glass in that they are comprised of vitreous and crystalline batch components. In examples, silica acts primarily as the key glass forming species within the glassy phase and governs the viscoelastic properties of the ECM within a given environment. ECMs are formulated to perform specific tasks and react beneficially in specific environments and applications to produce directed outcomes—unlike foam glass, which strives to be inert. ECMs differ, in general, from ceramic foams as well in that they require less heat to produce, and yet have the ability to agglomerate multiple silica, clay, and mineral constituents into stable cellular structures. ECMs additionally are designed such that they consists of largely glass character and are intended to end in a mixing of crystalline and glass phases.

Polyphase cellular magmatics describe an ECM wherein the finished product is comprised of crystalline and amorphous phases within the same magmatic structure, as described above. In describing the structure of the foamed material or article, a cellular void refers to the available space within an individual cell, vesicle or bubble. Cell wall refers to the material separating one cell from another, and generally, but not always, comprises the most considerable portion of the article's dry mass. A pyroplastic mass refers to the result of individual grains of the powdered vitreous and other constituents, as a whole, beginning to melt, adhere and comingle with one another such that they may attain a suspension viscosity that allows them to flow in reaction to the thermal decomposition of blowing and reactive agents, either resisting (forming vesicles) or incorporating said agents.

Systems to generate the polyphase magmatics described herein may include, for example, a conveyor element such as a conveyor belt configured to move the starting materials into a kiln and move produced engineered cellular magmatics from the kiln to a holding container. The system may also include a material dispenser that may be configured to hold constituent materials. The material dispenser may be positioned at a point before the kiln such that as materials exit the material dispenser and land on the conveyor element, the conveyor element may convey the materials into the kiln. The material dispenser may be substantially adjacent to the kiln and may have an opening on an end of the material dispenser proximal to the conveyor element. The opening may allow the constituent materials to flow from the material dispenser onto the conveyor element. The opening may be adjustable such that more or less constituent material is allowed to flow from the material dispenser to the conveyor element, either continuously or in batches. The system may additionally include one or more kilns.

The kiln may be configured to allow a portion of the conveyor element to pass through at least a portion of the kiln such that the constituent materials may enter an interior portion of the kiln, and engineered cellular magmatic products may exit the kiln. For example, the kiln may have a channel configured to receive a portion of the conveyor element, with a first end of the kiln configured to receive the constituent materials via the conveyor element and a second end of the kiln, opposite the first end, configured to output a product from the kiln. The kiln may be configured to apply heat to the constituent material as it travels through the kiln. In examples, the amount of heat applied by the kiln to the constituent materials may be adjustable. For example, the kiln can be divided into zones, with each zone having an adjustable temperature, such that a variety of temperatures and dwell times may be applied to the material. For example, the temperature in various zones of the kiln may be set to between about 400° Celsius and about 1,400° Celsius, such that the appropriate working or sintering temperature of constituent materials might be reached, as well as reaching the thermal decomposition temperature of other constituent materials. For example, a temperature of the kiln may be adjusted to be the at a first temperature about 25% of the way through the kiln, and then set to a higher temperature 50% of the way through the kiln such that the materials reach a working point and/or sintering temperature thermal and where thermal decomposition could occur in the blowing agent, and then a third temperature might be established 75% of the way through the kiln such that the now foamaceous mass may be allowed to temper, and not significantly fracture upon cooling after it leaves the kiln. Thereafter, the temperature may also vary depending on the speed at which the conveyor element is moving though the kiln as well. In examples, the time between when the constituent materials enter the kiln and when an engineered cellular magmatic product exits the kiln may be between about 30 minutes and about 90 minutes.

When a material dispenser is used, it may be caused to release the mixture onto the conveyor element such that a layer and/or piles of the material, and or bands of the material are formed on the conveyor element. It should be understood that while a blowing agent and a constituent glass material are utilized herein by way of example, the process may include more than one blowing agent and more than one other constituent material or may be followed by additional processing steps not specified here. A fundamental cellular magmatic may include at least one blowing agent, and at least one vitreous material capable of being sintered into a foamaceous mass in the presence of a blowing agent. Said vitreous material need not be glass in a strict sense, but should, under temperature, and in concert with either a blowing agent or additional constituent material, produce a crystalline phase within the magmatic, subordinate to the amorphous properties generated and/or imbued by the vitreous components. The product exiting the kiln may be compacted and/or fractured (either naturally or by applying force). The fractured product may be collected and may be utilized for one or more purposes as described herein.

The systems may also include one or more computing components that may be utilized to control the operation of the various components of the systems. For example, the computing components may include one or more processors, one or more network interfaces, and/or memory storing instructions that, when executed, cause the one or more processors to perform operations associated with the manufacture of engineered cellular magmatics. For example, the operations may include controlling the speed at which the conveyor element moves, the volume of constituent material that exits one or more of the material dispensers, an amount of constituent material added to the dispensers for each batch, a time at which the dispensers start and/or stop allowing constituent materials to travel from the dispensers to the conveyor element, a temperature and/or temperature gradient at which to set the kiln and/or specific zones within the kiln, and/or when to enable and/or disable one or more components of the systems. The computing components may include one or more input mechanisms such as a keyboard, mouse, touchscreen, etc. to allow a user of the system to physically provide input to the computing components to control the engineered cellular magmatic manufacturing systems.

Utilizing the systems and methods described herein, the resulting polyphase magmatics may be utilized for several purposes, such as insulation, geotechnical fill, the capture of pollutants, cleaning agents, abrasives, geotechnical fill, a component of cementitious materials, a component of an agglomerate, a media for filtration, a media for remediation, a media for catalytic conversion, a support media for biological species, a vehicle for nutrient materials, a media for enhancing rhizospheres, or other purposes requiring macroporous and/or mesoporous structures that either react with a target environment, balance a target environment, or a non-reactive in a target environment, by design.

The present disclosure provides an overall understanding of the principles of the structure, function, manufacture, and use of the systems and methods disclosed herein. One or more examples of the present disclosure are illustrated in the accompanying drawings. Those of ordinary skill in the art will understand that the systems and methods specifically described herein and illustrated in the accompanying drawings are non-limiting embodiments. The features illustrated or described in connection with one embodiment may be combined with the features of other embodiments, including as between systems and methods. Such modifications and variations are intended to be included within the scope of the appended claims.

Additional details of these and other examples are described below with reference to the drawings.

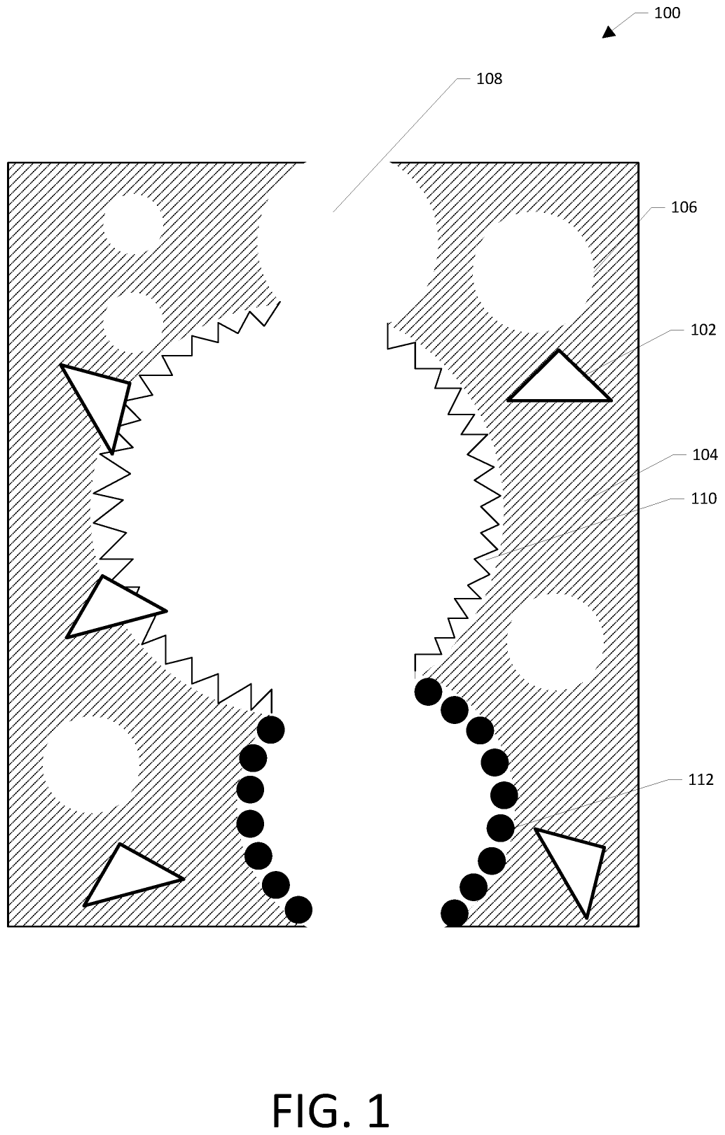

FIG. 1 illustrates a cross-sectional view of an example polyphase cellular magmatic 100. While FIG. 1 shows the polyphase cellular magmatic 100 having flat sides and being approximately rectangular in shape, this shape is provided by way of example and is not limiting. The exterior of the magmatic 100 may be of any shape and/or may be of a desired shape that is designed and obtained during manufacture of the magmatic 100. The components of the magmatic 100 are described below by way of example.

For example, the magmatics 100 may be configured to bind a crystalline phase 102 into the overall amorphous structure 104 while making the crystalline phase 102 available for interaction with other substances. In examples, the crystalline phases 102 are batch chemical phases (high refractory ceramic species) and/or crystalline phases 102 derived from a phase change or chemical reaction with other crystalline or glassy components. Further, secondary species can be derived during firing or upon specific chemical treatment postproduction—imbuing an article that is predominately amorphous with a crystalline fraction.

The magmatics 100 may also have closed cell structures 106 and/or open cell structures 108. For example, a closed cell structure 106 may comprise, in either the amorphous phases 104 and/or the crystalline phases 108, an open space that is not connected to other open spaces. By way of example, the magmatic 100 may have open spherical voids in the amorphous phases 104 and/or the crystalline phases 102. When those spherical voids are not connected to other spherical voids, the voids may be closed cell. When those spherical voids are connected to other spherical voids, the voids may be open cell. The cells may be of uniform or about uniform size throughout the magmatic structure, or some or all of the cells may differ in size. Additionally, while spherical voids are described herein by way of example, various other shapes of voids may be generated. In some examples, the crystalline phase 102 may not be associated with or otherwise contact the open cell structures 106 and/or closed cell structures 108. In other examples, the crystalline phase 102 may make up at least a portion of the wall of at least one cell structure (whether closed or open celled) in the magmatic 100. In addition to the above, the magmatic 100 may include one or more non-vesicular pores, which may be described as tunnels or otherwise tubes that run through at least a portion of the magmatic 100.

In addition to the above, one or more reactive agents may be applied to the magmatic 100 to imbue one or more portions of the magmatic 100 with reactive properties. For example, the reactive agents may be selected during manufacture of the magmatics 100 and may be disposed on certain portions of the resulting magmatic. By way of example, reactive agents 110, 112 may be disposed on one or more cell walls of a closed and/or open cell void in the magmatic 100. In some examples, a reactive crystalline agent 110 may be disposed on a first portion of the magmatic 100 while a reactive amorphous agent 112 may be disposed on a second portion of the magmatic. Additionally, one or more reactive agents may be disposed on an exterior portion of the magmatic 100, such as when a post-production imbuing is utilized. In these examples, the exterior reactive agent may be the same or different from the reactive agent disposed within the magmatic 100. Additionally, the exterior reactive agent may penetrate at least a portion of the magmatic, and in some examples may penetrate one or more of the cell structures of the magmatic 100.

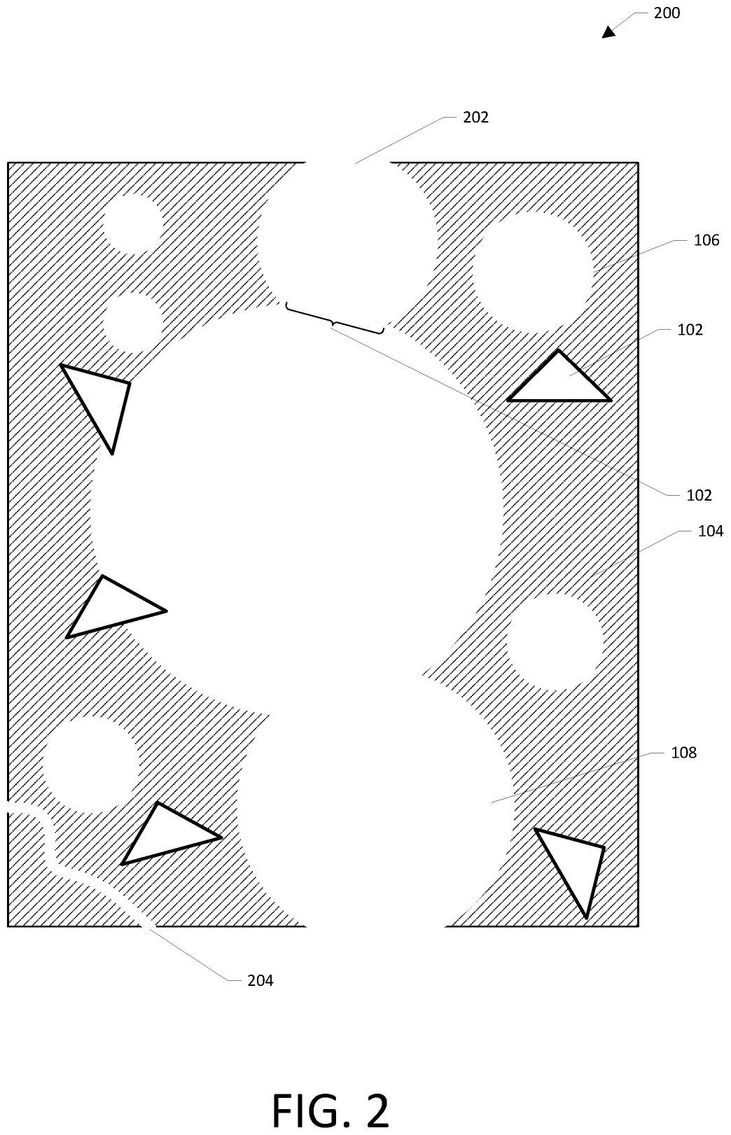

FIG. 2 illustrates a cross-sectional view of an example polyphase cellular magmatic 200 with open and closed cells, along with non-vesicular pores. While FIG. 2 shows the polyphase cellular magmatic 200 having flat sides and being approximately rectangular in shape, this shape is provided by way of example and is not limiting. The exterior of the magmatic 200 may be of any shape and/or may be of a desired shape that is designed and obtained during manufacture of the magmatic 200. The components of the magmatic 200 are described below by way of example.

For example, the magmatics 200 may be configured to bind a crystalline phase 102 into the overall amorphous structure 104 while making the crystalline phase 102 available for interaction with other substances. In examples, the crystalline phases 102 are batch chemical phases (high refractory ceramic species) and/or crystalline phases 102 derived from a phase change or chemical reaction with other crystalline or glassy components. Further, secondary species can be derived during firing or upon specific chemical treatment postproduction—imbuing an article that is predominately amorphous with a crystalline fraction.

The magmatics 200 may also have closed cell structures 106 and/or open cell structures 108. For example, a closed cell structure 106 may comprise, in either the amorphous phases 104 and/or the crystalline phases 108, an open space that is not connected to other open spaces. By way of example, the magmatic 200 may have open spherical voids in the amorphous phases 104 and/or the crystalline phases 102. When those spherical voids are not connected to other spherical voids, the voids may be closed cell. When those spherical voids are connected to other spherical voids, the voids may be open cell. The cells may be of uniform or about uniform size throughout the magmatic structure, or some or all of the cells may differ in size. Additionally, while spherical voids are described herein by way of example, various other shapes of voids may be generated. In some examples, the crystalline phase 102 may not be associated with or otherwise contact the open cell structures 106 and/or closed cell structures 108. In other examples, the crystalline phase 102 may make up at least a portion of the wall of at least one cell structure (whether closed or open celled) in the magmatic 200. In addition to the above, the magmatic 200 may include one or more non-vesicular pores 204, which may be described as tunnels or otherwise tubes that run through at least a portion of the magmatic 200.

The magmatics 200 described herein may include a rigid foamed mass, typified by an appearance akin to pumice or volcanic rock, that is manufactured in a kiln or furnace. Such articles may exhibit both open or closed-cell structures 106, 108, as well as open and closed cell structures 106, 108 in the same article. Said articles may also exhibit pore structure 202 comprised of interconnected cells where cell walls have collapsed to form subsequent vesicular corridors, or pore structures 202 without creating discontinuities in cells, or a combination of these aspects. ECM differ from foam glass in that they are comprised of vitreous and crystalline batch components. ECMs have a reduced glassy character and often a lower silica content, wherein the silica acts primarily as the key glass forming species within the glassy phase and governs the viscoelastic properties of the ECM within a given environment. ECMs are formulated to perform specific tasks and react beneficially in specific environments and applications to produce directed outcomes—unlike foam glass, which strives to be inert. ECMs differ, in general, from ceramic foams as well in that they require less heat to produce, and yet have the ability to agglomerate multiple silica, clay, and mineral constituents into stable cellular structures.

Polyphase cellular magmatics 200 describe ECMs wherein the finished product is comprised of crystalline phases 102 and amorphous phases 104 within the same magmatic structure, as described above. In describing the structure of the foamed material or article, a cellular void refers to the available space within an individual cell, vesicle or bubble. Cell wall refers to the sintered agglomerate of predominately vitreous material separating one cell from another, and generally, but not always, comprises the most considerable portion of the article's dry mass. A pyroplastic mass refers to the result of individual grains of the powdered vitreous and other constituents, as a whole, beginning to melt, adhere and comingle with one another such that they may attain a suspension viscosity that allows them to flow in reaction to the thermal decomposition of blowing and reactive agents, either resisting (forming vesicles) or incorporating said agents.

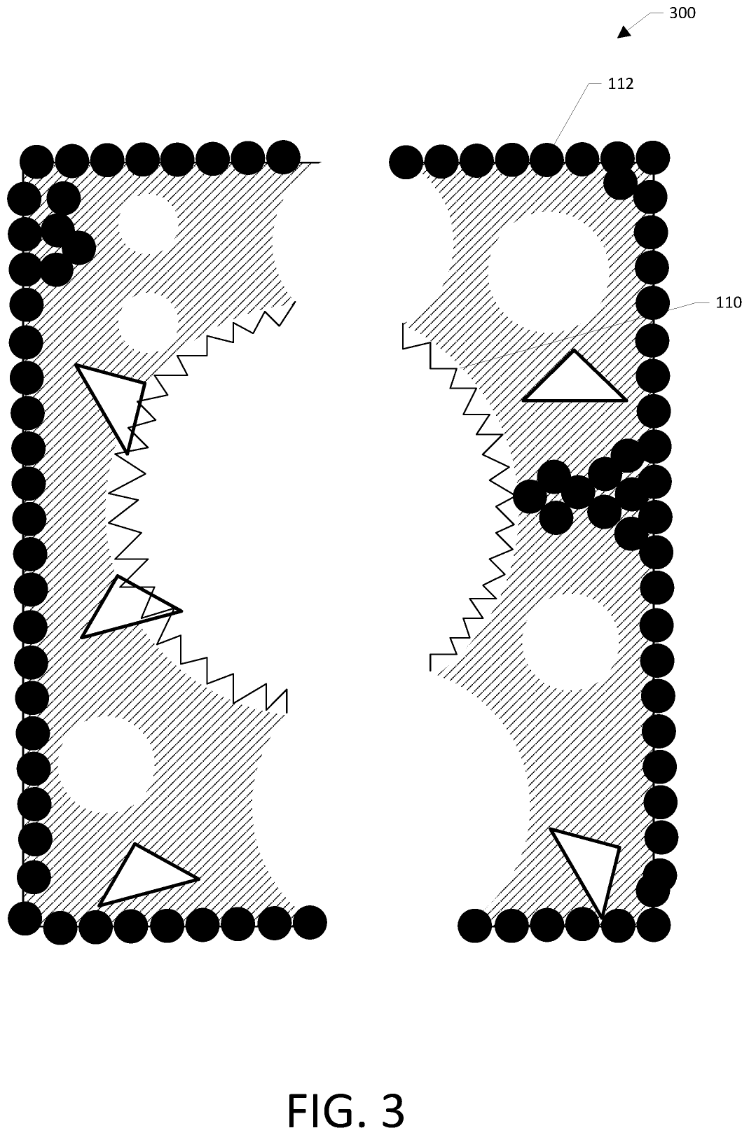

FIG. 3 illustrates a cross-sectional view of an example polyphase cellular magmatic 300 with interior and exterior reactive agents. While FIG. 3 shows the polyphase cellular magmatic 300 having flat sides and being approximately rectangular in shape, this shape is provided by way of example and is not limiting. The exterior of the magmatic 300 may be of any shape and/or may be of a desired shape that is designed and obtained during manufacture of the magmatic 300. The components of the magmatic 300 are described below by way of example.

For example, the magmatics 100 may be configured to bind a crystalline phase 102 into the overall amorphous structure 104 while making the crystalline phase 102 available for interaction with other substances. In examples, the crystalline phases 102 are batch chemical phases (high refractory ceramic species) and/or crystalline phases 102 derived from a phase change or chemical reaction with other crystalline or glassy components. Further, secondary species can be derived during firing or upon specific chemical treatment postproduction—imbuing an article that is predominately amorphous with a crystalline fraction.

In addition to the above, one or more reactive agents may be applied to the magmatic 300 to imbue one or more portions of the magmatic 300 with reactive properties. For example, the reactive agents may be selected during manufacture of the magmatics 300 and may be disposed on certain portions of the resulting magmatic. By way of example, reactive agents 110, 112 may be disposed on one or more cell walls of a closed and/or open cell void in the magmatic 300. In some examples, a reactive crystalline agent 110 may be disposed on a first portion of the magmatic 300 while a reactive amorphous agent 112 may be disposed on a second portion of the magmatic 300. Additionally, one or more reactive agents may be disposed on an exterior portion of the magmatic 300, such as when a post-production imbuing is utilized. In these examples, the exterior reactive agent may be the same or different from the reactive agent disposed within the magmatic 300. Additionally, the exterior reactive agent 112 may penetrate at least a portion of the magmatic, and in some examples may penetrate one or more of the cell structures of the magmatic 300. For example, as shown in FIG. 3, the exterior reactive agent 112 may be applied during firing of the magmatic 300 and/or postproduction. As shown in FIG. 3, the exterior reactive agent covers at least a portion of the exterior of the magmatic 300 and has penetrated at least a portion of the exterior of the amorphous portion of the magmatic 300 down to at least one of the cell structures of the magmatic 300. In this way, the exterior of the magmatic 300 has been imbued with the reactive properties of the exterior reactive agent 112 and the exterior reactive agent 112 has come into contact with at least a portion of the crystalline reactive agent 110, providing additional and different reactive properties to the area of the magmatic 300 where the reactive agents 110, 112 meet.

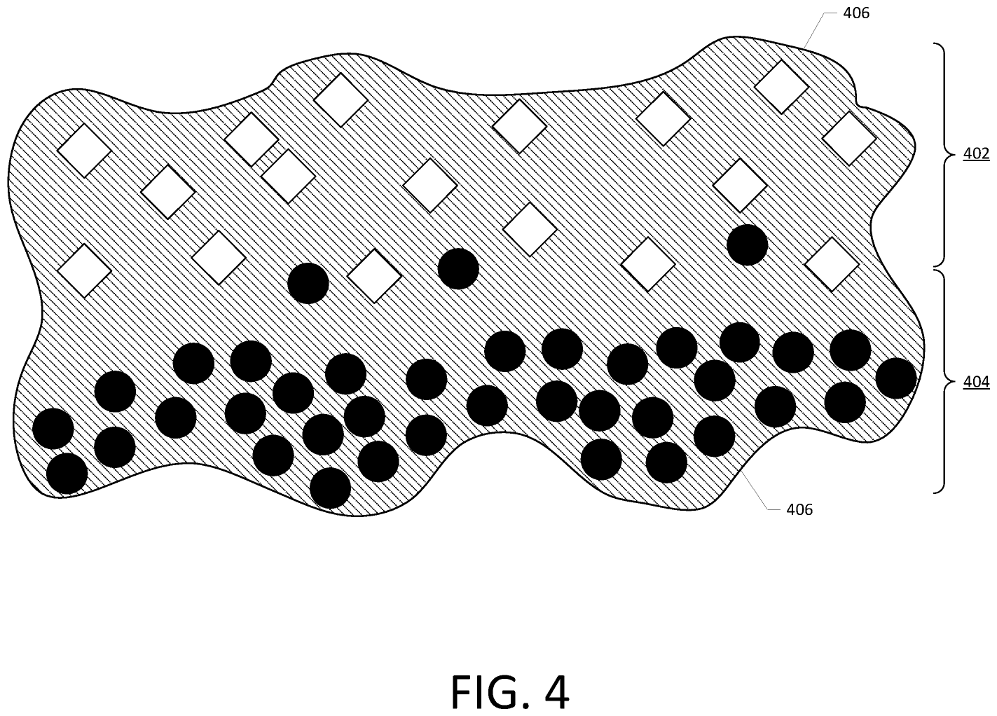

FIG. 4 illustrates a cross-sectional view of an example polyphase cellular magmatic 400 with multiple layers and a reactive agent in different states across layers. The magmatic 400 of FIG. 4 is shown as an amorphous structure with no straight exterior portions. However, it should be appreciated that the exterior shape of the magmatic 400 may differ from that shown specifically in FIG. 4.

The magmatics 400 may include one or more layers 402, 404 of reactive agents 406. For example, during manufacturing of the magmatics 400, specific temperatures, dwell times, and/or heating gradients may be applied to cause at least a portion of a reactive agent 406 to form a different chemical substance and/or state than the original reactive agent. In these examples, the original reactive agent 406 and the different chemical substance and/or state may at least partially separate into one or more layers 402, 404 in the magmatic 400. By so doing, a first layer 402 of the magmatic may include first reactive properties when one or more substances contact the first layer 402, and specifically the reactive agent 406 of the first layer, while a second layer 404 of the magmatic 400 may include second, different reactive properties when one or more substances contact the second layer 404, and specifically the reactive agent 406 of the second layer 404.

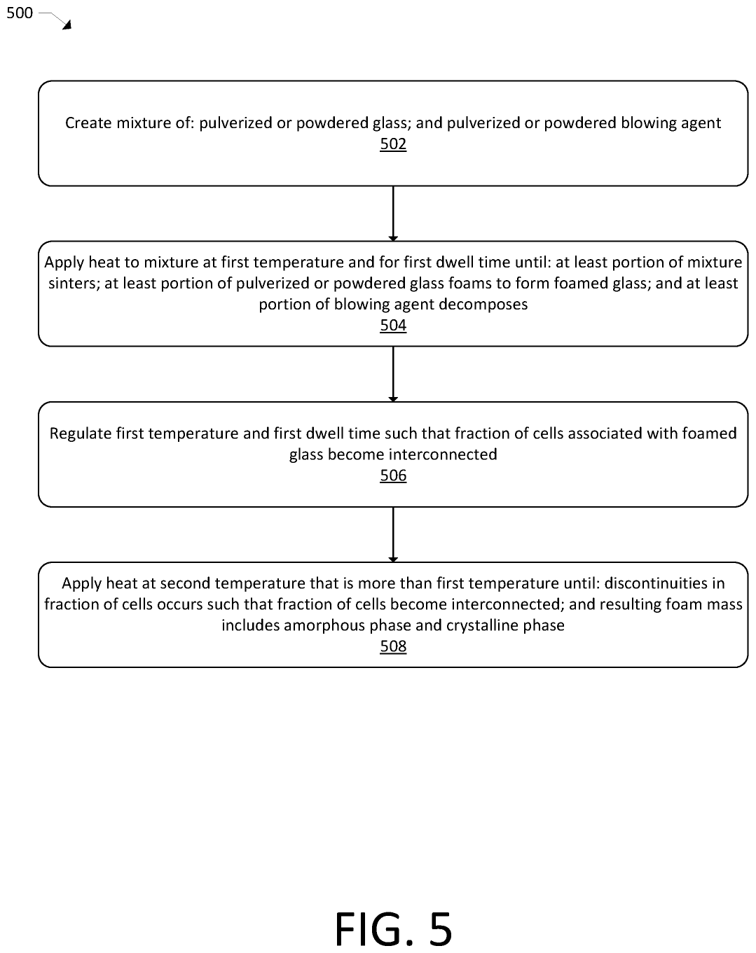

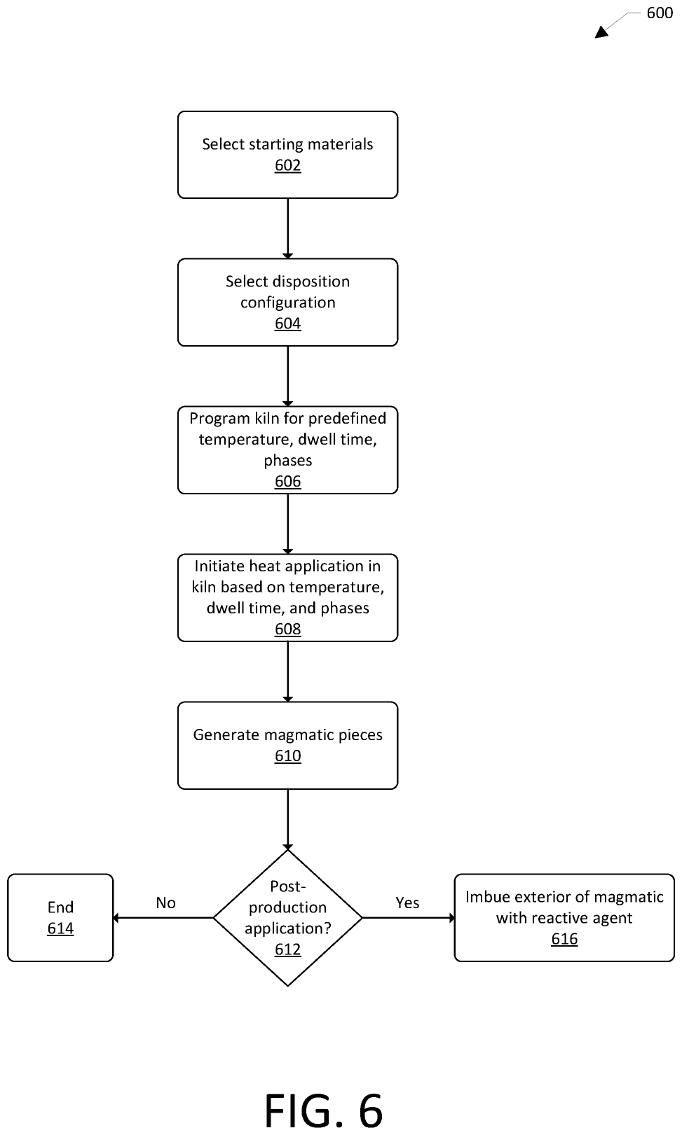

FIGS. 5 and 6 illustrate processes for generation of polyphase cellular magmatics. The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, such as, for example those described with respect to FIGS. 1-4 and 7, although the processes may be implemented in a wide variety of other environments, architectures and systems.

FIG. 5 is a flowchart illustrating an example process 500 for generating polyphase cellular magmatics. The order in which the operations or steps are described is not intended to be construed as a limitation, and any number of the described operations may be combined in any order and/or in parallel to implement process 500.

At block 502, the process 500 may include creating a mixture of: a pulverized or powdered glass; and a pulverized or powdered blowing agent. For example, the glass and/or blowing agent may be pulverized and/or powdered to a unit size specific to the application at issue and the desired resulting magmatic. In examples, the grain size of the glass and/or blowing agent components may be smaller, sometimes significantly smaller, than the intended voids to be generated in the resulting magmatic. The glass component may include, for example, one or more of soda-lime glass, flint, container glass, a-glass, flat glass, e-glass, c-glass, ar-glass, s-glass, single phase borosilicate glass, phase separated borosilicate, fused silica, coal slags, metal slags, nickel slag, smelting slags, mineral wool, and/or boron. It should be understood that these glass materials are provided by way of illustration, and not as a limitation. The blowing agents may include one or more of aluminum slag, anthracite, activated carbon, calcium carbonate, calcium sulfate, carbon black, cellulose, coal, fly ash, graphite, magnesium carbonate, potassium nitrate, silicon carbide, silicon nitride, sodium hydroxide, sodium nitrate, sodium nitrite, and/or zinc oxide. Again, it should be understood that these glass materials are provided by way of illustration, and not as a limitation.

The mixture may also include one or more reactive agents. The reactive agents may include, for example, alumina, bauxite, sodium aluminate, periclase, hematite, wüstite, magnetite, enamel, zircon, zirconium dioxide, silicon carbide, silicon nitride, garnet, spinel, kaolin, clays, zeolites, incinerator ash, and/or pyrolysis ash. Again, it should be understood that these reactive agents are provided by way of illustration, and not as a limitation.

At block 504, the process 500 may include applying heat to the mixture at a first temperature and for a first dwell time until: at least a portion of the mixture sinters; at least a portion of the pulverized or powdered glass foams to form a foamed glass; and at least a portion of the blowing agent decomposes. For example, the resulting mixture may be placed into a kiln or other heating component and a temperature may be applied until at least a portion of the mixture decomposes into a gas or gases, forming a distribution of cellular voids within the resulting foamaceous mass. In situations where a reactive agent is included in the mixture, application of heat in the kiln may be performed until, in examples, the reactive agent comprises a significant fraction of the surface area of the foamaceous mass and/or until the reactive agent comprises a residue on surfaces of the foamaceous mass.

At block 506, the process 500 may include regulating the first temperature and the first dwell time such that a fraction of cells associated with the foamed glass become interconnected. In examples, application of heat may be performed until, for example, the materials sinter and at least a portion of the mixture foams by thermal decomposition of the blowing agent and/or agents.

At block 508, the process 500 may include applying heat at a second temperature that is more than the first temperature until: discontinuities in the fraction of cells occurs such that the fraction of cells become interconnected; and a resulting foam mass includes an amorphous phase and a crystalline phase. For example, the temperature and dwell times may be regulated such that at least a fraction of the cells of the foamaceous mass become interconnected by discontinuities in the cell walls. This discontinuity may be caused at least in part by pressure from escaping gases and/or constituent secondary blowing agents having a higher decomposition temperature than other blowing agents. The temperatures, dwell times, and heating gradients used with respect to the kiln may be adjusted to achieve a desired resulting magmatic. For example, adjusting one or more of the temperature, the dwell times, and/or the heating gradients may result in magmatics with differing cell size, porosity, open versus closed cells, inclusion or exclusion of non-vesicular pores, inclusion or exclusion of reactive agents on cell walls and/or other portions of the magmatic, differing densities, inclusion of more or less crystalline phase, inclusion or exclusion of layers, inclusion or exclusion of reactive agent derivatives, etc.

Additionally, or alternatively, the process 500 may include including a reactive agent in the mixture prior to applying the heat. In these examples, the reactive agent may be a compound that, upon thermal decomposition, imparts reactive properties to the foam mass such that, when the foam mass contacts a substance associated with the reactive agent, a chemical reaction occurs with respect to the reactive agent. Additionally, or alternatively, in these examples the reactive agent may be at least one of alumina, bauxite, sodium aluminate, periclase, hematite, wüstite, magnetite, enamel, zircon, zirconium dioxide, silicon carbide, silicon nitride, garnet, spinel, kaolin, clays, zeolites, incinerator ash, and/or pyrolysis ash.

The first temperature could be around 500 Celsius. Which is then ramped to a temperature of 850 Celsius at a rate of 20 K/min followed by a hold at the temperature of 850 Celsius for 15 minutes. This is then subsequently quenched at a fast rate (typically exceeding 50 K/min) until a low temperature (such as 100 Celsius) is reached.

Additionally, or alternatively, the process 500 may include the temperature being from about from about 20 degrees Celsius to about 220 degrees Celsius for about 10 minutes, the second temperature being from about 225 degrees Celsius to about 350 degrees Celsius for about 10 minutes, a third temperature being from about 350 degrees Celsius to about 500 degrees Celsius for about 10 minutes, and a fourth temperature being from about 500 degrees Celsius to about 800 degrees Celsius for about 20 minutes.

Additionally, or alternatively, the process 500 may include the heat being applied at the second temperature for a period of time until at least two layers are formed in the foam mass.

Additionally, or alternatively, the process 500 may include, after creating the mixture and based at least in part on an intended structure of the foam mass, selecting a disposition configuration for the mixture on a conveyor belt configured to transport the mixture to a kiln for applying the heat, the disposition configuration including at least one of a layer, a pile, or a band. The process 500 may also include disposing the mixture on the conveyor belt utilizing the disposition configuration.

Additionally, or alternatively, the process 500 may include, after the foam mass is created, applying a post-production treatment to the foam mass, the post-production treatment including application of a reactive agent that imbues the foam mass with a crystalline fraction on an exterior portion of the foam mass.

FIG. 6 is a flowchart illustrating another example process 600 for generating polyphase cellular magmatics. The order in which the operations or steps are described is not intended to be construed as a limitation, and any number of the described operations may be combined in any order and/or in parallel to implement process 600.

At block 602, the process 600 may include selecting starting materials for forming a polyphase cellular magmatic. For example, the starting materials may include a glass component, a blowing agent, and/or one or more reactive agents.

The glass component may include, for example, one or more of soda-lime glass, flint, container glass, a-glass, flat glass, e-glass, c-glass, ar-glass, s-glass, single phase borosilicate glass, phase separated borosilicate, fused silica, coal slags, metal slags, nickel slag, smelting slags, mineral wool, and/or boron. It should be understood that these glass materials are provided by way of illustration, and not as a limitation.

The blowing agents may include one or more of aluminum slag, anthracite, activated carbon, calcium carbonate, calcium sulfate, carbon black, cellulose, coal, fly ash, graphite, magnesium carbonate, potassium nitrate, silicon carbide, silicon nitride, sodium hydroxide, sodium nitrate, sodium nitrite, and/or zinc oxide. Again, it should be understood that these glass materials are provided by way of illustration, and not as a limitation.

The reactive agents may include, for example, alumina, bauxite, sodium aluminate, periclase, hematite, wüstite, magnetite, enamel, zircon, zirconium dioxide, silicon carbide, silicon nitride, garnet, spinel, kaolin, clays, zeolites, incinerator ash, and/or pyrolysis ash. Again, it should be understood that these reactive agents are provided by way of illustration, and not as a limitation.

At block 604, the process 600 may include selecting a disposition configuration for the mixture of materials. For example, when a material dispenser is used, it may be caused to release the mixture onto the conveyor element such that a layer and/or piles of the material, and or bands of the material are formed on the conveyor element. It should be understood that while a blowing agent and a constituent glass material are utilized herein by way of example, the process may include more than one blowing agent and more than one other constituent material. A fundamental cellular magmatic may include at least one blowing agent, and at least one vitreous material capable of being sintered into a foamaceous mass in the presence of a blowing agent. Said vitreous material need not be glass in a strict sense, but should, under temperature, and in concert with either a blowing agent or additional constituent material, produce a crystalline phase within the magmatic, subordinate to the amorphous properties generated and/or imbued by the vitreous components. The product exiting the kiln may be compacted and/or fractured (either naturally or by applying force). The fractured product may be collected and may be utilized for one or more purposes as described herein.

At block 606, the process 600 may include programming a kiln for a predefined temperature, dwell time, and phases. For example, the kiln may be associated with one or more computing components that may be programmed to achieve a desired temperature, dwell time, and heating phases within the kiln.

At block 608, the process 600 may include initiating heat application in kiln based on temperature, dwell time, and phases. For example, an operator may provide user input to cause the computing components to initiate the heating application as programmed. In other examples, a scheduled start time may be programmed based at least in part on a day and/or time, and/or when a condition is satisfied, such as when the starting materials are determined to be present and/or when safety measures are satisfied, such as safety barriers being determined to be cleared and/or the absence of human presence in some or all of the components of the system that includes the kiln.

At block 610, the process 600 may include generating magmatic pieces. For example, the magmatic may be generated as described above and herein. The magmatic may be configured to bind a crystalline phase into the overall amorphous structure while making the crystalline phase available for interaction with other substances. In examples, the crystalline phases are batch chemical phases (high refractory ceramic species) and/or crystalline phases derived from a phase change or chemical reaction with other crystalline or glassy components. Further, secondary species can be derived during firing or upon specific chemical treatment postproduction—imbuing an article that is predominately amorphous with a crystalline fraction.

In addition to the above, one or more reactive agents may be applied to the magmatic to imbue one or more portions of the magmatic with reactive properties. For example, the reactive agents may be selected during manufacture of the magmatics and may be disposed on certain portions of the resulting magmatic. By way of example, reactive agents may be disposed on one or more cell walls of a closed and/or open cell void in the magmatic. In some examples, a reactive crystalline agent may be disposed on a first portion of the magmatic while a reactive amorphous agent may be disposed on a second portion of the magmatic. Additionally, one or more reactive agents may be disposed on an exterior portion of the magmatic, such as when a post-production imbuing is utilized. In these examples, the exterior reactive agent may be the same or different from the reactive agent disposed within the magmatic. Additionally, the exterior reactive agent may penetrate at least a portion of the magmatic, and in some examples may penetrate one or more of the cell structures of the magmatic.

At block 612, the process 600 may include determining whether post-production application of a reactive agent is to occur. For example, when the kiln is programmed as described above, part of the programming may include an indication of whether post-production application of a reactive agent is to occur. In other examples, the input may include selection of a given reactive property on an exterior portion of the magmatic. In these examples, the computing components of the kiln may be configured to determine that post-production application of a reactive agent is to occur to achieve the indicated reactive property.

In instances where post-production application of the reactive agent is not to occur, the process 600 may end at block 614. In these examples, the resulting magmatic may be in a state indicated to be desired when the programming input was received such that no additional production steps are needed.

In instances where post-production application is to occur, the process 600 may include, at block 616, imbuing at least a portion of an exterior of the magmatic with a reactive agent. For example, the post-production application may include exposing at least a portion of the exterior of the magmatics to the selected reactive agent such that the reactive agent binds to the exterior of the magmatic and/or reacts with the exterior of the magmatic until a reactive agent residue is imbued to the exterior of the magmatic.

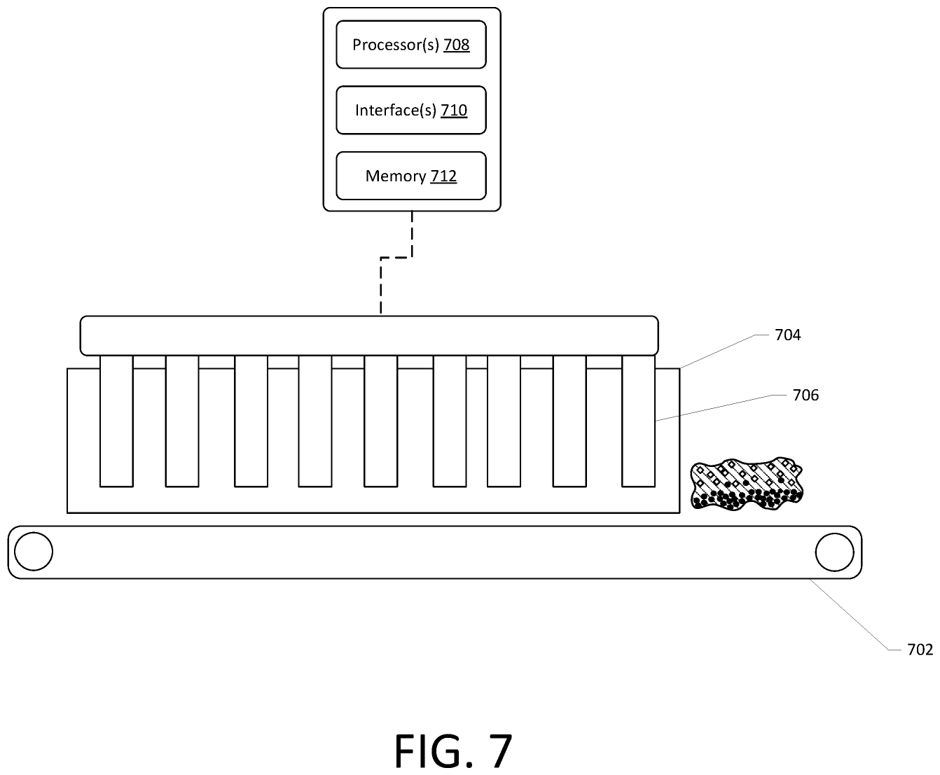

FIG. 7 illustrates a schematic view of a system 700 for generating polyphase cellular magmatics.

In addition to the above, the system 700 may include, for example, computing components. Each of these components will be described below by way of example.

The conveyor element 702, which may be a conveyor belt, may be configured to move precursor materials into the kiln 704 and move produced polyphase cellular magmatics from the kiln 704 to a holding container (not depicted). The conveyor element 702 may be configured to vary the speed at which the conveyor element 702 moves precursor materials. For example, the speed of movement of the conveyor element 702 may be adjustable such that an amount of time from when the precursor material enter the kiln 704 and when the produced polyphase magmatics exit the kiln 704 may be varied. In examples, the amount of time may be between about 10 minutes and about 50 minutes.

Additionally, one or more hoppers may be configured to hold precursor materials. The hoppers may be positioned at a point before the kiln 704 such that as materials exit the hoppers and are transferred to the conveyor element 702, the conveyor element 702 may convey the materials into the kiln 704. The hoppers may be substantially adjacent to each other and each hopper may have an opening on an end of the hoppers proximal to the conveyor element 702. The opening may allow the precursor materials to flow from the hoppers onto the conveyor element 702. The opening may be adjustable such that more or less precursor material is allowed to flow from the hoppers to the conveyor element 702. The hoppers may also include a wheel, roller, and/or drum housed within the hoppers and configured to rotate to promote the flow of precursor material within the hoppers and through the opening. The wheel, roller, and/or drum may be configured to turn at various, adjustable speeds to increase or decrease the flow of precursor material from the hoppers to the conveyor element 702.

While one or more examples described herein discuss the hoppers generally holding precursor material, it should be understood that the hoppers may all hold the same precursor material or one or more of the hoppers may hold a precursor material that differs in one or more respects from precursor material held by another of the hoppers. For example, a precursor material may include a glass-grade silica powder, ground glass, and/or silica-lime glass, for example. The precursor materials may also include one or more foaming agents and/or reactive components. The types of precursor materials and/or the quantities of precursor materials, both within a given hopper and/or as between hoppers, may vary from hopper to hopper.

The kiln 704 may be configured to allow a portion of the conveyor element 702 to pass through at least a portion of the kiln 704 such that the precursor materials may enter an interior portion of the kiln 704, and polyphase cellular aggregates may exit the kiln 704. For example, the kiln 704 may have a channel configured to receive a portion of the conveyor element 702, with a first end of the kiln 704 configured to receive the precursor materials via the conveyor element 702 and a second end of the kiln 704, opposite the first end, configured to output a product from the kiln 704. In examples, the kiln 704 may be positioned relative to the second section of the conveyor element 702. The kiln 704 may be configured to apply heat to the precursor material as it travels through the kiln 704. The system may also include one or more heat ducts 706, which may be configured to apply heat and/or to allow for heat to exit the kiln 704. In examples, the amount of heat applied by the kiln 704 to the precursor materials may be adjustable. For example, the temperature inside the kiln 704 may be between about 20 degrees Celsius and about 900 degrees Celsius for an example run time. In further examples, the kiln 704 may be configured to apply a heating gradient and/or differing temperatures to the precursor materials as they travel through the kiln 704. The temperature may vary depending on, for example, the speed at which the conveyor element 702 is moving and/or specifications for the polyphase cellular magmatic desired as output from the kiln 704.

The one or more computing components may be utilized to control the operation of the various components of the system 700. For example, the computing components may include one or more processors 708, one or more network interfaces 710, and/or memory 712 storing instructions that, when executed, cause the one or more processors 708 to perform operations associated with the manufacture of polyphase cellular magmatics. For example, the operations may include controlling the speed at which the conveyor element 702 moves, the volume of material that exits one or more of the hoppers, a time at which the hoppers are moved for filling of materials and/or for placement above the conveyor element 702, an amount of material added to the hoppers, a time at which the hoppers start and/or stop allowing materials to travel from the hoppers to the conveyor element 702, a temperature and/or temperature gradient at which to set the kiln 704, and/or when to enable and/or disable one or more components of the system 700. The computing components may include one or more input mechanisms such as a keyboard, mouse, touchscreen, etc. to allow a user of the system to physically provide input to the computing components to control the silicate aggregate manufacturing systems.

Additionally, or alternatively, the one or more network interfaces 710 may be configured to receive data from one or more other devices, such as mobile devices and/or remote servers and/or remote systems. In these examples, the received data may cause the system 700 to perform one or more of the operations described above such that a user need not be physically present at the system 700 to operate it. Additionally, the network interfaces 710 may be utilized to send data associated with the operations of the system 700 to the one or more other devices. By so doing, one or more remote operators and/or users may be enabled to observe operation of the system 700 without necessarily being physically present at the system 700. In these examples, the system 700 may include one or more sensors that may generate data indicating operational parameters of the system 700. For example, one or more temperature sensors, pressure sensors, motion sensors, and/or weight and/or volume sensors may be included in the system.

As used herein, a processor, such as processor 708, may include multiple processors and/or a processor having multiple cores. Further, the processors may comprise one or more cores of different types. For example, the processors may include application processor units, graphic processing units, and so forth. In one implementation, the processor may comprise a microcontroller and/or a microprocessor. The processor(s) 708 may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 708 may possess its own local memory, which also may store program components, program data, and/or one or more operating systems.

The memory 712 may include volatile and nonvolatile memory, removable and non-removable media implemented in any method or technology for storage of information, such as computer-readable instructions, data structures, program component, or other data. Such memory 712 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory 712 may be implemented as computer-readable storage media (“CRSM”), which may be any available physical media accessible by the processor(s) 708 to execute instructions stored on the memory 712. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information and which can be accessed by the processor(s) 708.

Further, functional components may be stored in the respective memories, or the same functionality may alternatively be implemented in hardware, firmware, application specific integrated circuits, field programmable gate arrays, or as a system on a chip (SoC). In addition, while not illustrated, each respective memory, such as memory 712, discussed herein may include at least one operating system (OS) component that is configured to manage hardware resource devices such as the network interface(s), the I/O devices of the respective apparatuses, and so forth, and provide various services to applications or components executing on the processors. Such OS component may implement a variant of the FreeBSD operating system as promulgated by the FreeBSD Project; other UNIX or UNIX-like variants; a variation of the Linux operating system as promulgated by Linus Torvalds; the FireOS operating system from Amazon. com Inc. of Seattle, Wash., USA; the Windows operating system from Microsoft Corporation of Redmond, Wash., USA; LynxOS as promulgated by Lynx Software Technologies, Inc. of San Jose, Calif.; Operating System Embedded (Enea OSE) as promulgated by ENEA AB of Sweden; and so forth.

The network interface(s) 710 may enable messages between the components and/or devices shown in system 700 and/or with one or more other remote systems, as well as other networked devices. Such network interface(s) 710 may include one or more network interface controllers (NICs) or other types of transceiver devices to send and receive messages over a network.

For instance, each of the network interface(s) 710 may include a personal area network (PAN) component to enable messages over one or more short-range wireless message channels. For instance, the PAN component may enable messages compliant with at least one of the following standards IEEE 802.15.4 (ZigBee), IEEE 802.15.1 (Bluetooth), IEEE 802.11 (WiFi), or any other PAN message protocol. Furthermore, each of the network interface(s) 710 may include a wide area network (WAN) component to enable message over a wide area network.

While various examples and embodiments are described individually herein, the examples and embodiments may be combined, rearranged and modified to arrive at other variations within the scope of this disclosure.

Although embodiments have been described in language specific to structural features and/or methodological acts, it is to be understood that the disclosure is not necessarily limited to the specific features or acts described. Rather, the specific features and acts are disclosed herein as illustrative forms of implementing the claimed subject matter. Each claim of this document constitutes a separate embodiment, and embodiments that combine different claims and/or different embodiments are within the scope of the disclosure and will be apparent to those of ordinary skill in the art after reviewing this disclosure.

What is claimed is:

1. An article of manufacture, comprising:
a rigid foam mass being composed of at least one silicate based component and having:
a non-crystalline portion disposed such that the non-crystalline portion is configured to interact with a substance that comes into contact with the rigid foam mass; and
a crystalline portion that is bound to the amorphous portion, in line with the definition of glass ceramics;
wherein at least one of the amorphous portion or the crystalline portion includes a material configured to react when contacted by the substance.

2. The article of manufacture of claim 1, wherein the rigid foam mass includes open cell structures.

3. The article of manufacture of claim 1, wherein the rigid foam mass includes closed cell structures.

4. The article of manufacture of claim 1, wherein the rigid foam mass includes open cell structures and closed cell structures.

5. An article of manufacture, comprising:
an engineered foam mass having:
an amorphous portion disposed such that the amorphous portion is configured to interact with a substance that contacts the amorphous portion; and
a crystalline portion bound to the amorphous portion, the crystalline portion disposed such that the crystalline portion is configured to at least contact the substance;
wherein at least one of the amorphous portion or the crystalline portion includes a material configured to react when contacted by the substance.

6. The article of manufacture of claim 5, wherein the material includes at least one of alumina, bauxite, sodium aluminate, periclase, hematite, wüstite, magnetite, enamel, zircon, zirconium dioxide, silicon carbide, silicon nitride, garnet, spinel, kaolin, clays, zeolites, incinerator ash, soda, limestone, or pyrolysis ash.

7. The article of manufacture of claim 5, wherein the amorphous portion comprises a first layer of the engineered foam mass and the crystalline portion comprises a second layer of the engineered foam mass, the first layer differing from the second layer.

8. The article of manufacture of claim 5, wherein the substance is a first substance, and the amorphous portion includes the reactive component in a first state configured to interact with the substance and the crystalline portion includes the reactive component in a second state configured to at least one of not interact with the first substance or interact with a second substance that differs from the first substance.

9. The article of manufacture of claim 5, wherein at least one of the amorphous portion or the crystalline portion includes vesicular corridors.

10. The article of manufacture of claim 5, wherein the crystalline portion is imbued on an exterior of the engineered foam mass.

11. The article of manufacture of claim 5, wherein the amorphous portion includes open cell structures and the crystalline portion includes closed cell structures.

12. The article of manufacture of claim 5, wherein the crystalline portion includes open cell structures and the amorphous portion includes closed cell structures.

13. A method comprising:
creating a mixture of:
a pulverized or powdered glass; and
a pulverized or powdered blowing agent;
applying heat to the mixture at a first temperature and for a first dwell time until:
at least a portion of the mixture sinters;
at least a portion of the pulverized or powdered glass foams to form a foamed glass; and
at least a portion of the blowing agent decomposes; and
at least a portion of the foamed glass at least one of remains in the crystalline state or undergoes crystallization
regulating the first temperature and the first dwell time such that:
a fraction of cells associated with the foamed glass become interconnected;
discontinuities in the fraction of cells occurs such that the fraction of cells become interconnected; and
a resulting foam mass includes an amorphous phase and a crystalline phase.

14. The method of claim 13, further comprising including a reactive agent in the mixture prior to applying the heat.

15. The method of claim 14, wherein the reactive agent is a compound that, upon thermal decomposition, imparts reactive properties to the foam mass such that, when the foam mass contacts a substance associated with the reactive agent, a chemical reaction occurs with respect to the reactive agent.

16. The method of claim 13, wherein the reactive agent includes at least one of alumina, bauxite, sodium aluminate, periclase, hematite, wüstite, magnetite, enamel, zircon, zirconium dioxide, silicon carbide, silicon nitride, garnet, spinel, kaolin, clays, zeolites, incinerator ash, or pyrolysis ash.

17. The method of claim 13, wherein the first temperature is about 500 Celsius, and the method further comprises:
applying a second temperature of about 850 Celsius at a rate of 20 K/min followed by a hold at the temperature of 850 Celsius for 15 minutes; and
reducing heat at a rate exceeding 50 K/min until a third temperature of about at least 100 Celsius is reached.

18. The method of claim 13, wherein the heat is applied at the second temperature until at least two layers are formed in the foam mass.

19. The method of claim 13, further comprising:
after creating the mixture and based at least in part on an intended structure of the foam mass, selecting a disposition configuration for the mixture on a conveyor belt configured to transport the mixture to a kiln for applying the heat, the disposition configuration including at least one of a layer, a pile, or a band; and
disposing the mixture on the conveyor belt utilizing the disposition configuration.

20. The method of claim 13, further comprising, after the foam mass is created, applying a post-production treatment to the foam mass, the post-production treatment including application of a reactive agent that imbues the foam mass with a crystalline fraction on an exterior portion of the foam mass.
